(19) United States
(12) Patent Application Publication
(10) Pub. No.: US 2019/0367040 A1
(43) Pub. Date: Dec. 5, 2019

(54) INFORMATION PROCESSING DEVICE, TRAVEL DATA PROCESSING METHOD, VEHICLE, AND PROGRAM RECORDING MEDIUM

(71) Applicant: NEC Corporation, Minato-ku, Tokyo (JP)

(72) Inventors: Yoshio KAMEDA, Tokyo (JP); Wemer WEE, Tokyo (JP); Riki ETO, Tokyo (JP)

(73) Assignee: NEC Corporation, Minato-ku, Tokyo (JP)

(21) Appl. No.: 16/487,145

(22) PCT Filed: Mar. 15, 2018
(86) PCT No.: PCT/JP2018/010313

§ 371 Date: Aug. 20, 2019

(30) Foreign Application Priority Data
Mar. 23, 2017 (JP) 2017-056889

(51) Int. Cl. B60W 40/09; B60W 50/10; G05D 1/00

(52) U.S. Cl. CPC B60W 40/09; B60W 2050/0029; G05D 1/0088; B60W 50/10

(57) ABSTRACT

This information processing device is equipped with: an actual travel data acquisition means that acquires actual travel data, which is travel data obtained by the driving of a vehicle by a driver; a simulated travel data acquisition means that uses travel environment data indicating the travel environment associated with the travel, and a driver model that determines the operation of the vehicle with respect to the travel environment, to acquire simulated travel data, which is travel data obtained from a simulator that simulates the driving of the vehicle by the driver; and a comparison means that compares the values of multiple indices of the actual driving data and the values of multiple indices of the simulated travel data, and that outputs the comparison results.

### TECHNICAL FIELD

The present disclosure relates to an information processing device configured to control travel of a vehicle, a travel data processing method, a vehicle, and a program recording medium.

### BACKGROUND ART

There is proposed an automatic travel control device that generates a travel control plan for causing a vehicle to travel automatically. Particularly, a travel-control-plan generation device, which is capable of generating a travel control plan for causing a vehicle to travel automatically while reflecting a driving preference of a driver, is proposed.

For example, PTL 1 discloses a travel-control-plan generation device including a plan generation means for generating a travel control plan through use of a travel-control-plan generation parameter in which a driving preference of a driver is reflected. With this device, a driving preference of a driver is reflected in a travel-control-plan generation parameter, and a travel control plan is generated through use of the parameter. With this, a vehicle can drive automatically while reflecting a driving preference of a driver.

PTL 2 discloses a driving assistance device that learns travel data while a vehicle is caused to travel by a driving operation of a driver and performs driving assistance, based on the learnt result. With this device, vehicle speed data are learnt, and driving assistance is performed, based on the learnt result. With this, a vehicle can travel automatically while reflecting a driving preference relating to vehicle speed as intended by a driver.

PTL 3 discloses a driving assistance device of a vehicle, which provides a driver with information for evoking eagerness of improvement in fuel efficiency. With this device, an estimated fuel consumption and an actual fuel consumption, which is actually consumed during following travel, are calculated, and a result acquired by comparing the two values is output. With this, a driver can evaluate fuel efficiency of a vehicle by oneself in real time in a successive or timely manner, and can be conscious of driving suitable for fuel efficiency.

PTL 4 discloses a sewage treatment process simulator that can automatically perform parameter setting required for modeling. With this simulator, analysis data accumulated in a data accumulation device and data accumulated in a simulation result accumulation device are compared, and a simulation result is evaluated, based on a predetermined equation.

### CITATION LIST

### Patent Literature

### [PTL 1] Japanese Patent No. 4952268

### [PTL 2] Japanese Patent No. 5839010

### [PTL 3] Japanese Unexamined Patent Application Publication No. 2013-222235

### [PTL 4] Japanese Unexamined Patent Application Publication No. 2000-167585

### SUMMARY OF INVENTION

### Technical Problem

In general, a plurality of indexes such as vehicle speed, acceleration and deceleration, and fuel efficiency are exemplified as indexes for expressing preferences of a driver. Meanwhile, there is a problem in that the above-mentioned technologies disclosed in PTLs 1 to 4 cannot evaluate a driver model in consideration of a plurality of indexes.

The invention of the present application has been made in view of the above-mentioned problem, and has a main object to provide an information processing device, which enables evaluation of a driver model in consideration of a plurality of indexes, and the like.

### Solution to Problem

One aspect of the invention is an information processing device. The information processing device includes actual travel data acquisition means which acquires actual travel data acquired during travel of a vehicle, which is performed by a driver; simulation travel data acquisition means which acquires simulation travel data acquired by a simulator that simulates travel of the vehicle, which is performed by the driver, through use of travel environment data indicating a travel environment relating to the travel and a driver model for determining an operation of the vehicle with respect to the travel environment; and comparison means which compares values for a plurality of indexes in the actual travel data and values for the plurality of indexes in the simulation travel data, and which outputs a comparison result.

One aspect of the invention is a travel data processing method. The travel data processing method includes acquiring actual travel data acquired during travel of a vehicle, which is performed by a driver, and simulation travel data acquired by a simulator that simulates travel of the vehicle, which is performed by the driver, through use of travel environment data indicating a travel environment relating to the travel and a driver model for determining an operation of the vehicle with respect to the travel environment; and comparing values for a plurality of indexes in the actual travel data and values for the plurality of indexes in the simulation travel data and outputting a comparison result.

One aspect of the invention is a vehicle. The vehicle includes a sensor which acquires travel data relating to travel of a vehicle, which is performed by a driver; and an information processing device, the information processing device comprising: actual travel data acquisition means which acquires the travel data acquired by the sensor as actual travel data; simulation travel data acquisition means which acquires simulation travel data acquired by a simulator that simulates travel of the vehicle, which is performed by the driver, through use of travel environment data indicating a travel environment relating to the travel and a driver model for determining an operation of the vehicle with respect to the travel environment; and comparison means which compares values for a plurality of indexes in the actual travel data and values for the plurality of indexes in the simulation travel data, and which outputs a comparison result; wherein the driver model determines an operation of the vehicle through use of a predetermined objective function using weights relating to the plurality of indexes, and the information processing device further comprises adjustment means which adjusts weights relating to the plurality of indexes, based on differences between the values for the plurality of indexes in the actual travel data and the values for the plurality of indexes in the simulation travel data.

One aspect of the invention is a vehicle. The vehicle includes a sensor which acquires travel data relating to travel of a vehicle, which is performed by a driver; and communication means which receives a driver model using an objective function using weights having been adjusted from an information processing device, the information processing device comprising: actual travel data acquisition means which acquires the travel data acquired by the sensor as actual travel data; simulation travel data acquisition means which acquires simulation travel data acquired by a simulator that simulates travel of the vehicle, which is performed by the driver, through use of travel environment data indicating a travel environment relating to the travel and the driver model for determining an operation of the vehicle with respect to the travel environment; and comparison means which compares values for a plurality of indexes in the actual travel data and values for the plurality of indexes in the simulation travel data, and which outputs a comparison result; wherein the driver model determines an operation of the vehicle through use of the predetermined objective function using the weights relating to the plurality of indexes, and the information processing device further comprises adjustment means which adjusts the weights relating to the plurality of indexes, based on differences between the values for the plurality of indexes in the actual travel data and the values for the plurality of indexes in the simulation travel data.

One aspect of the invention is a program recording medium. The program recording medium records a computer program causing a computer to execute: processing of acquiring actual travel data acquired during travel of a vehicle, which is performed by a driver; processing of acquiring simulation travel data acquired by a simulator that simulates travel of the vehicle, which is performed by the driver, through use of travel environment data indicating a travel environment relating to the travel and a driver model for determining an operation of the vehicle with respect to the travel environment; and processing of comparing values for a plurality of indexes in the actual travel data and values for the plurality of indexes in the simulation travel data, and outputting a comparison result.

### Advantageous Effects of Invention

According to the invention of the present application, an effect of enabling evaluation of a driver model in consideration of a plurality of indexes can be exerted.

### BRIEF DESCRIPTION OF DRAWINGS

FIG. 1 is a block diagram illustrating a configuration of an information processing device according to a first example embodiment of the present invention.

FIG. 2 is a block diagram illustrating a configuration of an information processing device according to a second example embodiment of the present invention.

FIG. 3 is a diagram illustrating one example of actual travel data of the information processing device according to the second example embodiment of the present invention.

FIG. 4 is a diagram illustrating one example of simulation travel data stored in a simulation travel data storage unit of the information processing device according to the second example embodiment of the present invention.

FIG. 5 is a flowchart illustrating an operation of the information processing device according to the second example embodiment of the present invention.

FIG. 6 is a diagram illustrating one example of evaluation values in actual travel data acquired by an evaluation unit of the information processing device according to the second example embodiment of the present invention.

FIG. 7 is a diagram illustrating one example of evaluation values in simulation travel data acquired by the evaluation unit of the information processing device according to the second example embodiment of the present invention.

FIG. 8A is a diagram illustrating one example of a comparison result between the simulation travel data and the actual travel data, which is acquired by the evaluation unit of the information processing device according to the second example embodiment of the present invention.

FIG. 8B is a diagram illustrating one example of a comparison result between the simulation travel data and the actual travel data, which is acquired by the evaluation unit of the information processing device according to the second example embodiment of the present invention.

FIG. 8C is a diagram illustrating one example of a comparison result between the simulation travel data and the actual travel data, which is acquired by the evaluation unit of the information processing device according to the second example embodiment of the present invention.

FIG. 9 is a diagram illustrating another example of a comparison result between the simulation travel data and the actual travel data, which is acquired by the evaluation unit of the information processing device according to the second example embodiment of the present invention.

FIG. 10 is a block diagram illustrating a configuration of an information processing device according to a third example embodiment of the present invention.

FIG. 11 is a flowchart illustrating an operation of the information processing device according to the third example embodiment of the present invention.

FIG. 12A is a diagram illustrating one example of a comparison result between simulation travel data and actual travel data, which is acquired by an evaluation unit of the information processing device according to the third example embodiment of the present invention.

FIG. 12B is a diagram illustrating one example of a comparison result between the simulation travel data and the actual travel data, which is acquired by the evaluation unit of the information processing device according to the third example embodiment of the present invention.

FIG. 12C is a diagram illustrating one example of a comparison result between the simulation travel data and the actual travel data, which is acquired by the evaluation unit of the information processing device according to the third example embodiment of the present invention.

FIG. 13 is a block diagram illustrating a configuration of a vehicle according to a fourth example embodiment of the present invention.

FIG. 14 is a block diagram illustrating configurations of a vehicle and an information processing device according to a fifth example embodiment of the present invention.

FIG. 15 is a diagram illustrating one example of a hardware configuration for achieving the device illustrated in each of the example embodiments.

### EXAMPLE EMBODIMENT

Now, with reference to the drawings, detail description is made on example embodiments of the present invention.

### First Example Embodiment

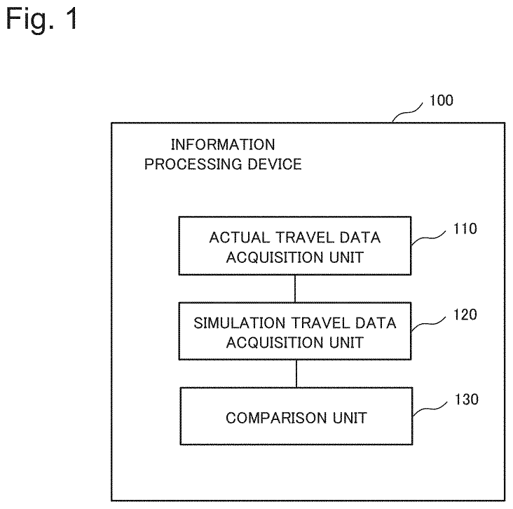

FIG. 1 is a block diagram illustrating a configuration of an information processing device 100 according to a first example embodiment of the present invention. As illustrated in FIG. 1, the information processing device 100 includes an actual travel data acquisition unit 110, a simulation travel data acquisition unit 120, and a comparison unit 130.

The actual travel data acquisition unit 110 acquires actual travel data acquired during travel of a vehicle, which is performed by a driver. The simulation travel data acquisition unit 120 acquires simulation travel data acquired by a simulator that simulates travel of the vehicle, which is performed by the driver, through use of travel environment data on a travel environment relating to the travel and a driver model that determines an operation of the vehicle with respect to the travel environment. The comparison unit 130 compares values of a plurality of indexes in the actual travel data and values of the plurality of indexes in the simulation travel data, and outputs a comparison result. Note that, the actual travel data acquisition unit 110, the simulation travel data acquisition unit 120, and the comparison unit 130 are carried out by, for example, an actual travel data acquisition unit 211, a simulation travel data acquisition unit 241, and an evaluation unit 250, which are described later in the following example embodiments, respectively.

According to the first example embodiment, by adopting the above-mentioned configuration, the values of the plurality of indexes in the actual travel data and the values of the plurality of indexes in the simulation travel data are compared, and hence an effect of being capable of evaluating a driver model in consideration of the plurality of indexes can be exerted.

### Second Example Embodiment

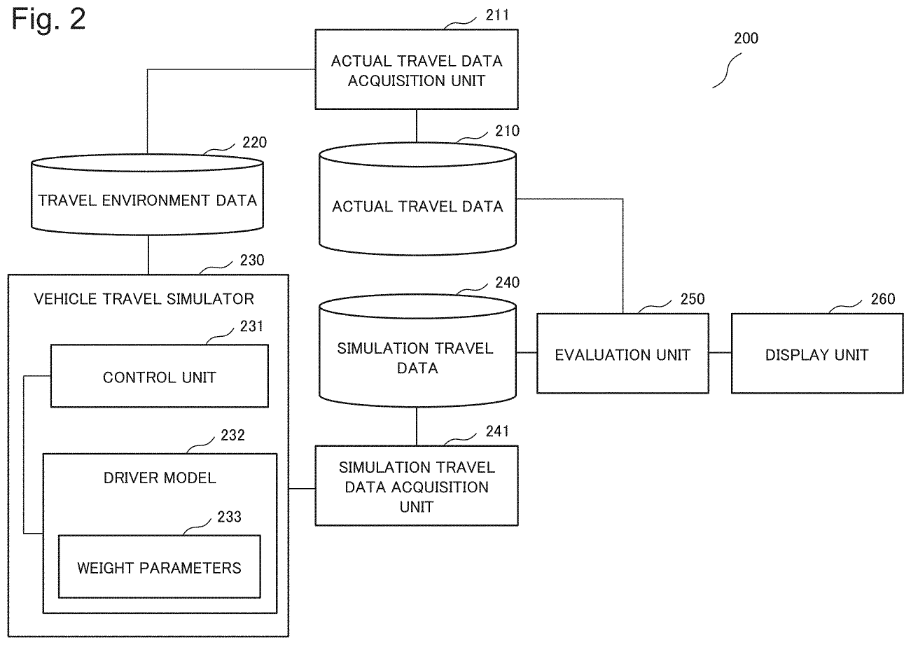

FIG. 2 is a block diagram illustrating a configuration of an information processing device 200 according to a second example embodiment of the present invention. As illustrated in FIG. 2, the information processing device 200 includes an actual travel data storage unit 210, the actual travel data acquisition unit 211, a travel environment data storage unit 220, a vehicle travel simulator 230, a simulation travel data storage unit 240, the simulation travel data acquisition unit 241, the evaluation unit 250, and a display unit 260. The vehicle travel simulator 230 includes a control unit 231 and a driver model 232. The driver model 232 includes weight parameters 233.

Description is made on an outline of each component of the information processing device 200.

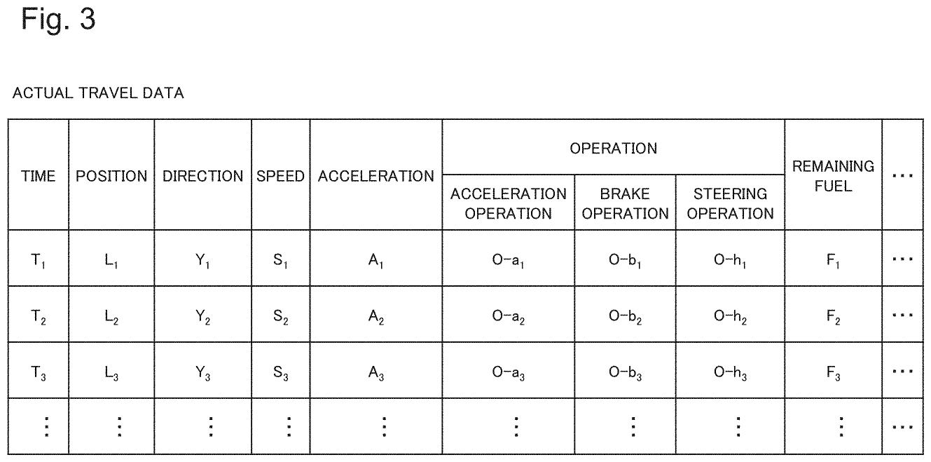

Information acquired during travel of a vehicle, which is performed by a driver, for example, actual travel data including a location, a direction, speed, and the like of the vehicle are stored in the actual travel data storage unit 210. The actual travel data acquisition unit 211 acquires the above-mentioned actual travel data, and stores the data in the actual travel data storage unit 210. FIG. 3 is a diagram illustrating one example of the actual travel data. As illustrated in FIG. 3, the actual travel data may include information indicating, for example, a location, a direction, speed, acceleration, an operation, a remaining fuel of a vehicle, which are associated with time for each predetermined time period. With regard to the operation, values indicating an acceleration operation, a brake operation, and a steering operation may be contained.

The actual travel data may be the above-mentioned information acquired while actual travel of a vehicle on a road surface is performed by a driver, or may be the above-mentioned information acquired while travel is performed in a simulator that reproduces the travel of the vehicle, which is performed by the driver.

Travel road information, environment information, and foreign object information at the time when the actual travel data stored in the actual travel data storage unit 210 are acquired are stored in the travel environment data storage unit 220. The travel road information includes information relating to a shape, a road width, a road surface condition, and the like of a travel road. The environment information includes information relating to illumination, weather, wind, and the like with regard to a travel road. The foreign object information includes information relating to a shape, a location, speed, acceleration, an indicator, and the like of a foreign object on a travel road or in a periphery thereof. The above-mentioned information for each predetermined time period may be stored in the travel environment data storage unit 220. The travel environment data may be acquired by the actual travel data acquisition unit 211, and may be stored in the travel environment data storage unit 220.

The vehicle travel simulator 230 reads, in the control unit 231, the travel environment data stored in the travel environment data storage unit 220, operates a vehicle through use of the driver model 232 while simulating an operation of a driver, and outputs various pieces of information relating the travel of the vehicle.

The driver model 232 is an algorithm that determines operations for travel of a vehicle such as an acceleration operation, a brake operation, and a steering operation, based on the travel environment data, that is, in accordance with the travel environment. The weight parameters 233 are a parameter to be used for reflecting a driving preference of a driver at the time when the driver model 232 determines an operation. The driver model 232 contains a predetermined objective function, and the weight parameters 233 are determined by optimizing the objective function. In this manner, a driving preference of a driver is reflected in a determined operation.

When speed, fuel consumption, and ride quality are used as evaluation indexes in which a driving preference of a driver is reflected, the objective function can be expressed with Equation (1) given below, for example.

Objective function=(W1*VS)+(W2*VF)+(W3*VA) (1)

In this case, VS, VF, and VA are variables indicating a speed evaluation index, a fuel-consumption evaluation index, and a ride-quality evaluation index, respectively. Further, W1, W2, and W3 are the weight parameters 233 of the speed evaluation index VS, the fuel-consumption evaluation index VF, and the ride-quality evaluation index VA, respectively, and are assumed to satisfy Equation (2) given below.

W1+W2+W3=1 (2)

The control unit 231 inputs the travel environment data, and determines such operations of a vehicle that the objective function is optimized (for example, minimized) through use of the driver model 232, for each predetermined time period. Further, the control unit 231 virtually controls the vehicle with the determined operations.

The simulation travel data acquisition unit 241 acquires the simulation travel data indicating information such as a location, a direction, and speed of the vehicle for each predetermined time period, the vehicle being operated virtually, based on the above-mentioned control. The simulation travel data storage unit 240 stores the simulation travel data acquired by the simulation travel data acquisition unit 241.

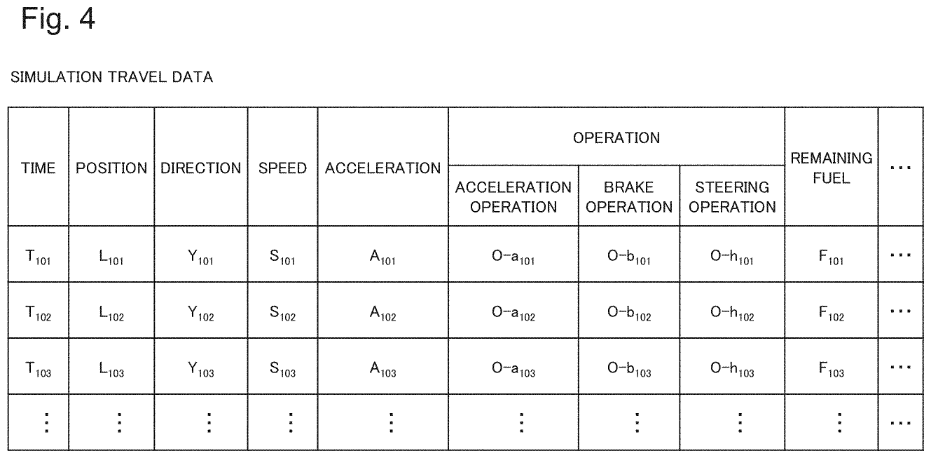

FIG. 4 is a diagram illustrating one example of the simulation travel data stored in the simulation travel data storage unit 240. As illustrated in FIG. 4, the simulation travel data include information on items similar to those in the actual travel data illustrated in FIG. 3.

The evaluation unit 250 has a function of comparing the actual travel data stored in the actual travel data storage unit 210 and the simulation travel data stored in the simulation travel data storage unit 240 with each other.

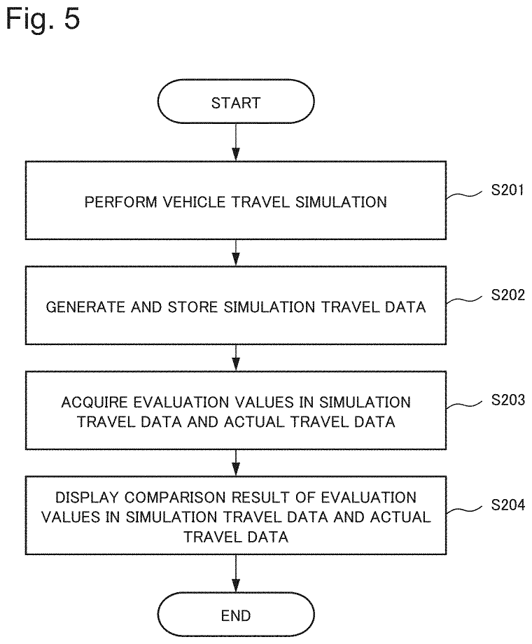

FIG. 5 is a flowchart illustrating an operation of the information processing device 200 according to the second example embodiment. With reference to FIG. 5, description is made on the operation of the information processing device 200. Note that it is assumed that the actual travel data illustrated in FIG. 3 are stored in the actual travel data storage unit 210. Further, it is assumed that the travel environment data relating to the environment in which the above-mentioned actual travel data are acquired are stored in the travel environment data storage unit 220.

The vehicle travel simulator 230 reads, in the control unit 231, the travel environment data stored in the travel environment data storage unit 220, and executes a simulation of vehicle travel through use of the driver model 232 (Step S201). In this case, the control unit 231 determines, for each predetermined time period, operations of the vehicle such as an acceleration operation, a brake operation, and a steering operation through use of the driver model 232 in order to optimize the objective function. Further, the control unit 231 virtually controls the vehicle with the determined operations.

The control unit 231 generates the simulation travel data including a location, a direction, speed, and the like of the vehicle for each predetermined time period at the time when the vehicle is virtually operated with the determined operations through use of the driver model 232 as described above, and stores the simulation travel data in the simulation travel data storage unit 240 (Step S202). In this case, it is assumed that the simulation travel data illustrated in FIG. 4 are stored in the simulation travel data storage unit 240.

Subsequently, as described above, the evaluation unit 250 acquires evaluation values regarding the evaluation indexes in the simulation travel data stored in the simulation travel data storage unit 240 and the actual travel data stored in the actual travel data storage unit 210 (Step S203). The evaluation indexes are set in advance, and in this case, for example, it is assumed that speed, fuel consumption, and ride quality are set as the evaluation indexes.

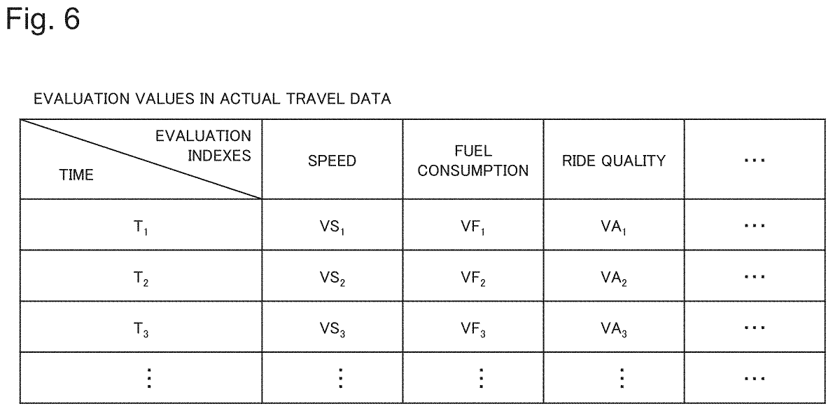

FIG. 6 is a diagram illustrating one example of evaluation values of the actual travel data acquired by the evaluation unit 250. As illustrated in FIG. 6, the evaluation values regarding speed, fuel consumption, and ride quality for each time period, which are contained in the actual travel data illustrated in FIG. 3, are acquired.

An evaluation value for speed is acquired, for example, from a value for “speed” contained in the actual travel data. For example, an evaluation value VS₁ for speed at time T₁ may be acquired from speed S₁ at the time T₁ and target speed VTS₁ as expressed in Equation (3) given below.

Evaluation value VS₁ for speed at time T₁=Speed S₁−Target speed VTS₁ (3)

The target speed VTS₁ may be given in advance in accordance with a road condition. For example, a speed limit and the like may be given based on map information.

An evaluation value for fuel consumption is acquired, for example, from a value for a “remaining fuel” and a “location” contained in the actual travel data. For example, an evaluation value VF₁ for fuel consumption at the time T₁ may be acquired with Equation (4) given below.

Evaluation value VF₁ for fuel consumption at time T₁=(Remaining fuel F₁−Remaining fuel F₂)/(Location L₂−Location L₁) (4)

An evaluation value for ride quality is acquired, for example, from a value for “acceleration” contained in the actual travel data. For example, an evaluation value VA₁ for ride quality at the time T₁ may be acceleration A₁ at the time T₁ as expressed in Equation (5) given below.

Evaluation value VA₁ for acceleration at time T₁=Acceleration A₁ (5)

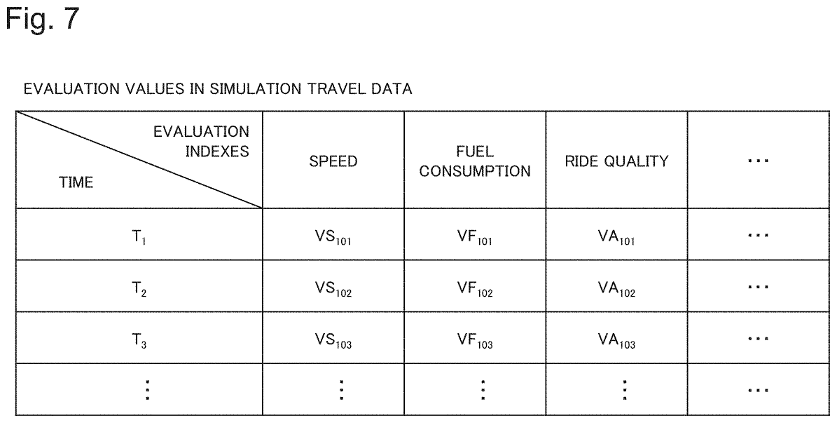

Ride quality may be acquired from a differential value for the acceleration. FIG. 7 is a diagram illustrating one example of evaluation values of the simulation travel data acquired by the evaluation unit 250. Similarly to the evaluation values in the actual travel data illustrated in FIG. 6, FIG. 7 illustrates that the evaluation values for speed, fuel consumption, and ride quality are acquired from the simulation travel data illustrated in FIG. 4.

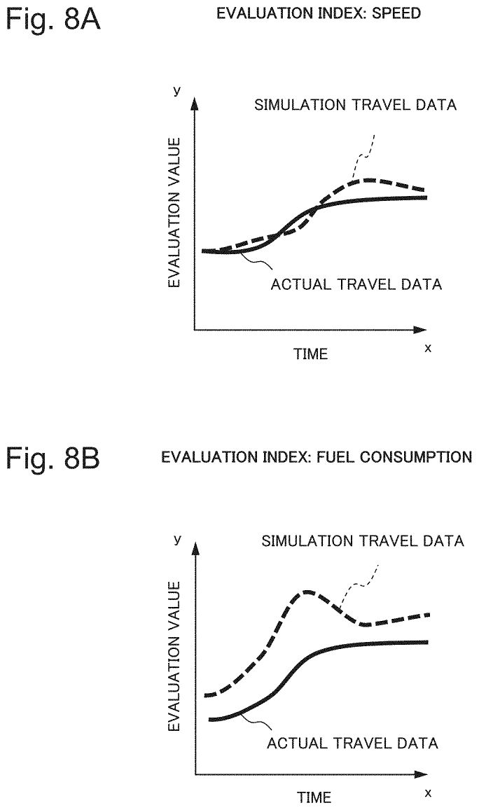

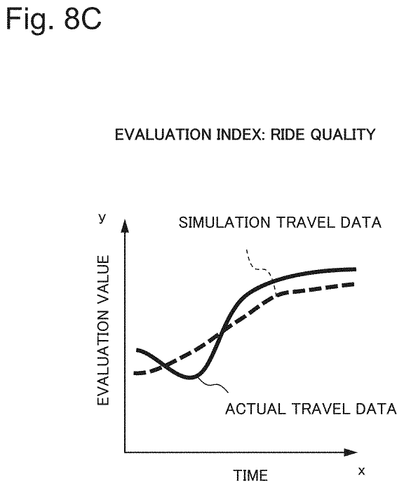

The evaluation unit 250 causes the display unit 260 to display the comparison result of the simulation travel data and the actual travel data based on the evaluation values acquired as described above (Step S204). FIGS. 8A, 8B, and 8C are diagrams illustrating examples in which the comparison result of the simulation travel data and the actual travel data is displayed on the display unit 260. FIGS. 8A, 8B, and 8C illustrate the comparison result of the simulation travel data and the actual travel data in the case where the evaluation indexes are speed, fuel consumption, and ride quality.

FIGS. 8A, 8B, and 8C illustrate result acquired in such manner that the evaluation values at each time in the simulation travel data and the actual travel data are plotted on an X-Y coordinate with a transverse axis (X axis) as “time” and a vertical axis (Y axis) as “evaluation value”. The evaluation values in the simulation travel data and the evaluation values in the actual travel data are expressed with dotted lines and solid lines, respectively.

As illustrated in FIG. 8A, the evaluation values in the simulation travel data and the actual travel data in the case where speed is set as an evaluation index are deviated from each other to a relatively small degree. Thus, it is conceived that a speed preference of the driver is reflected well in the driver model. The evaluation unit 250 may cause the evaluation index (in this case, speed), which is conceived to be reflected well in the driver model, to be displayed as the evaluation result.

In this case, the degree of deviation may be a time-averaged error rate of an evaluation value in the simulation travel data with respect to an evaluation value in the actual travel data. When the time-averaged error rate is smaller than a predetermined value, it may be determined that a preference of the driver with regard to the evaluation index is reflected well in the driver model, and when the time-averaged error rate is larger than the predetermined value, it may be determined that the preference of the driver is not reflected well.

As illustrated in FIG. 8B, the simulation travel data and the actual travel data in the case where fuel consumption is set as an evaluation index are deviated from each other to a relatively large degree. Thus, it is conceived that a preference of the drive r with regard to fuel consumption is not reflected well in the driver model. The evaluation unit 250 may cause the evaluation index (in this case, fuel consumption), which is not conceived to be reflected well in the driver model, to be displayed as the evaluation result.

Further, as illustrated in FIG. 8C, the simulation travel data and the actual travel data in which ride quality is set as an evaluation index are deviated from each other to a relatively small degree. Thus, it is conceived that a preference of a drive with regard to ride quality is reflected well in the driver model.

Note that, the evaluation unit 250 may cause a comparison result using values, which are acquired by normalizing the evaluation values in the simulation travel data and the actual travel data, to be displayed. By performing normalization, the evaluation unit 250 is capable of causing a comparison result, which are not affected by a magnitude of absolute values of the evaluation values, to be displayed. Further, the evaluation unit 250 may cause a comparison result to be displayed, the result using time averaged-values of the evaluation values in the simulation travel data and the actual travel data. By displaying the comparison result using the time-averaged values, a momentary change in the travel data can be removed to perform evaluation.

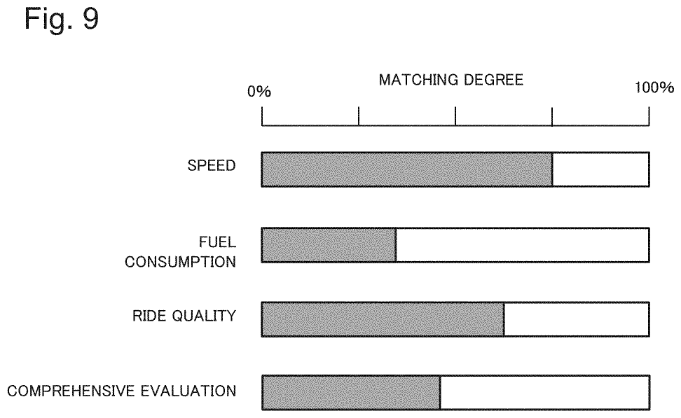

FIG. 9 is a diagram illustrating another example of a comparison result of the evaluation values in the simulation travel data and the actual travel data, which is acquired by the evaluation unit 250. As illustrated in FIG. 9, the evaluation unit 250 may indicate matching degrees (matching ratios) of the evaluation values in the simulation travel data with respect to the evaluation values in the actual travel data.

In FIG. 9, with regard to speed, fuel consumption, and ride quality being the evaluation indexes, matching degrees of the evaluation values in the simulation travel data with respect to the evaluation values in the actual travel data are illustrated. The matching degrees may be, for example, matching degrees between the time-averaged values of the evaluation values in the simulation travel data and the actual travel data. Further, the evaluation unit 250 may calculate an average value of the above-mentioned matching degrees with regard to speed, fuel consumption, and ride quality being the evaluation indexes, and may cause the calculated result to be displayed as a comprehensive evaluation.

As described above, according to the second example embodiment, the information processing device 200 acquires the actual travel data acquired during travel of a vehicle, which is performed by a driver, and the simulation travel data acquired by the vehicle travel simulator 230 through use of the driver model 232. The evaluation unit 250 compares the evaluation values, based on the plurality of evaluation indexes and causes the comparison result to be displayed, and hence an effect of enabling evaluation of the driver model 232 in consideration of the plurality of evaluation indexes can be exerted.

### Third Example Embodiment

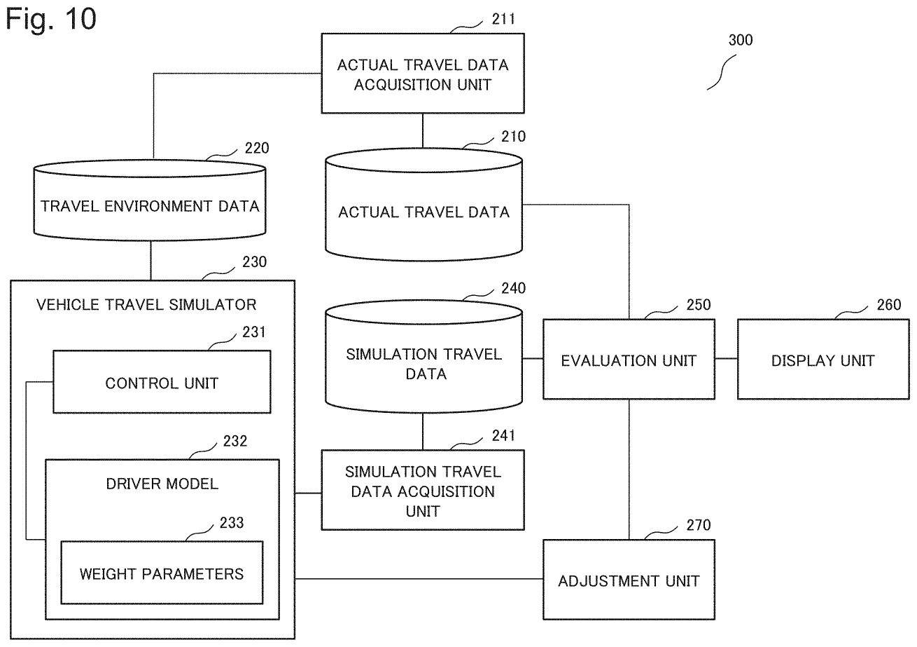

FIG. 10 is a block diagram illustrating a configuration of an information processing device 300 according to a third example embodiment of the present invention. As illustrated in FIG. 10, the information processing device 300 according to the third example embodiment includes an adjustment unit 270 in addition to the case of the information processing device 200 according to the above-mentioned second example embodiment.

The adjustment unit 270 has a function of adjusting weight parameters 233 contained in a driver model 232 of a vehicle travel simulator 230, based on the comparison result acquired by an evaluation unit 250.

As described in the second example embodiment, the weight parameters 233 are weight information for determining an operation of a vehicle in order to perform travel of the vehicle in which a driving preference of a driver is reflected, and can be expressed as in Equation (1) given above.

As described above in the second example embodiment, with regard to a certain evaluation index, when an evaluation value in the simulation travel data and an evaluation value in the actual travel data are deviated from each other by a predetermined value or more, it is conceived that a driving preference of a driver with regard to the evaluation index is not reflected well in the driver model. In view of this, in the third example embodiment, description is given on adjustment of the weight parameters, the adjustment performed to further reflect a driving preference of a driver, which is not conceived to be reflected well in the driver model, in the driver model.

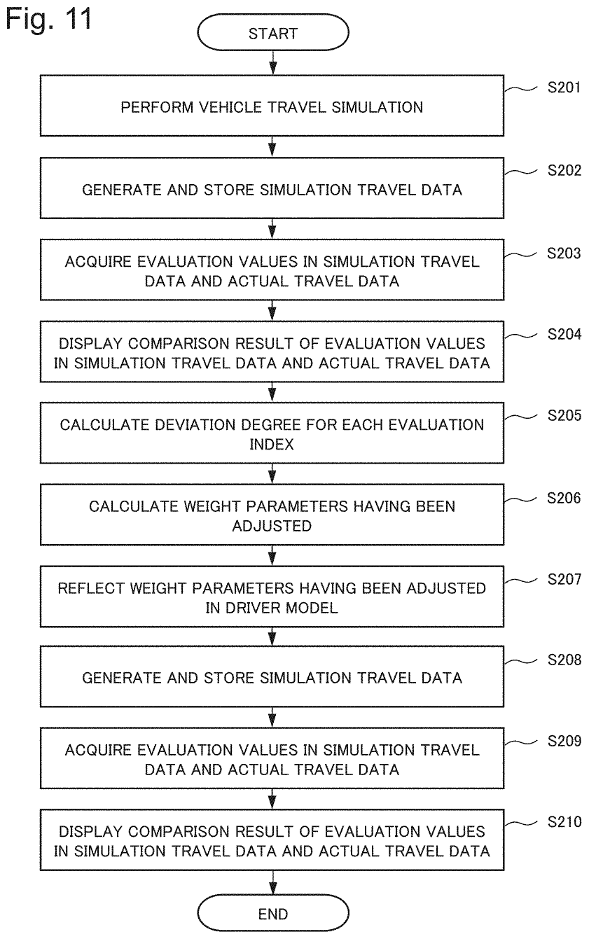

FIG. 11 is a flowchart illustrating an operation of the information processing device 300 according to the third example embodiment. In FIG. 11, the processing in Step S201 to Step S204 is the same as that in the steps with the same reference symbols in FIG. 5 in the second example embodiment. Thus, description therefor is omitted, and description is made on Steps S205 to S210 in the present example embodiment.

Based on the comparison result acquired in Step S204, the adjustment unit 270 calculates a deviation degree for each evaluation index, the deviation degree indicating deviation of an evaluation value in the simulation travel data from an evaluation value in the actual travel data (Step S205). The deviation degree may be expressed using, for example, a time-averaged error rate of the evaluation value in the simulation travel data with respect to the evaluation value in the actual travel data.

In this case, the deviation degrees of the evaluation values in the simulation travel data with respect to the evaluation values in the actual travel data with regard to the evaluation indexes, specifically, speed, fuel consumption, and ride quality are expressed as E1, E2, and E3, respectively.

Further, weight parameters having been adjusted correspondingly to the weight parameters W1, W2, W3 in Equation (1) are expressed as W1′, W2′, and W3′, respectively.

Based on the above-mentioned deviation degree, the adjustment unit 270 calculates the weight parameters W1′, W2′, and W3′ (Step S206). For example, the adjustment unit 270 calculates the weight parameters W1′, W2′, and W3′ in such a way as to satisfy Equations (6) and (7) given below.

Wn′=Wn*(1+En)*C(n=1,2,3) (6)

W1′+W2′+W3′=1 (7)

Note that “C” is a constant with a numerator being 1 and a denominator being a total value of Wn*(1+En) where n=1, 2, and 3.

The adjustment unit 270 reflects the calculated weight parameters W1′, W2′, and W3′ in the weight parameters 233 of the driver model 232 (Step S207). In this case, the objective function of the driver model 232 is expressed as in Equation (1)′ given below.

Objective function=(W1′*VS)+(W2′*VF)+(W3′*VA) (1)′

As expressed in Equation (6), the larger the above-mentioned deviation degree is, the larger the weight parameter value is set. With this, the driver model 232 using the weight parameters 233 having been adjusted is an algorithm for determining an operation with more emphasis on an evaluation index having a large deviation degree. Note that, Equation (6) is merely one example, and an adjustment range for a parameter with a larger deviation degree may be increased by, for example, using En² in place of En, or may be prevented from being increased excessively by causing En to fall within a range of a maximum value.

The vehicle travel simulator 230 reads the travel environment data in the control unit 231, and determines, through use of the driver model 232, operations such as an acceleration operation, a brake operation, and a steering operation of the vehicle for each predetermined time period in such a way as to optimize the objective function using the weight parameters 233 adjusted (updated) as described above.

With the operations determined as described above, the control unit 231 virtually controls the vehicle. The control unit 231 generates the simulation travel data having been adjusted using the weight parameters 233 adjusted as described above. The control unit 231 stores the generated simulation travel data in the simulation travel data storage unit 240 (Step S208).

Subsequently, with respect to the simulation travel data having been adjusted, which are stored in the simulation travel data storage unit 240 as described above, and the actual travel data stored in the actual travel data storage unit 210, the evaluation unit 250 acquires evaluation values for the evaluation indexes described above in a similar manner as in Step S203 described above.

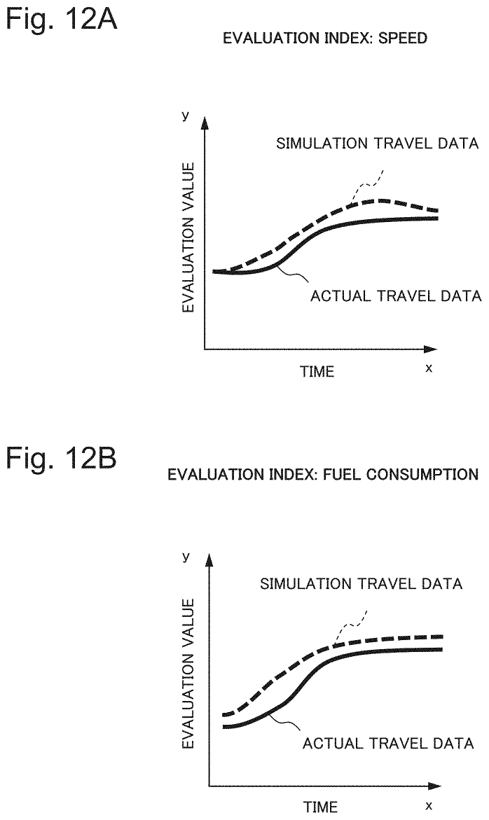

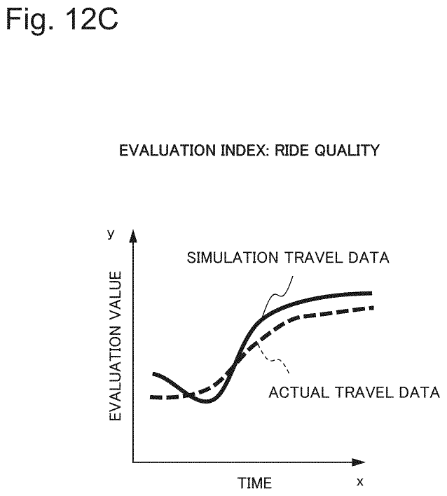

Subsequently, the evaluation unit 250 causes the display unit 260 to display a comparison result of the simulation travel data and the actual travel data based on the evaluation values acquired as described above (Step S210). Each of FIGS. 12A, 12B, and 12C is a diagram illustrating one example in which the display unit 260 displays the comparison result of the simulation travel data and the actual travel data. In FIGS. 12A, 12B, and 12C, the comparison results of the simulation travel data and the actual travel data are illustrated in a case where speed, fuel consumption, and ride quality are set as evaluation indexes.

As illustrated in FIG. 12B, a deviation degree between the simulation travel data and the actual travel data with regard to fuel consumption is smaller than that in the result illustrated in FIG. 8B. In this manner, by adjusting the weight parameters, based on the deviation degrees of the evaluation values in the simulation travel data and the actual travel data, the driver model 232 in which a driving preference of a driver is further reflected can be generated.

As described above, according to the third example embodiment, the evaluation unit 250 compares the simulation travel data and the actual travel data, based on the plurality of evaluation indexes, and adjusts the weight parameters 233 of the driver model 232 in such a way as to put emphasis on an evaluation index with a large deviation degree. By adopting this configuration, according to the third example embodiment, an effect of being capable of generating the driver model in consideration of balance among the plurality of evaluation indexes can be exerted.

### Fourth Example Embodiment

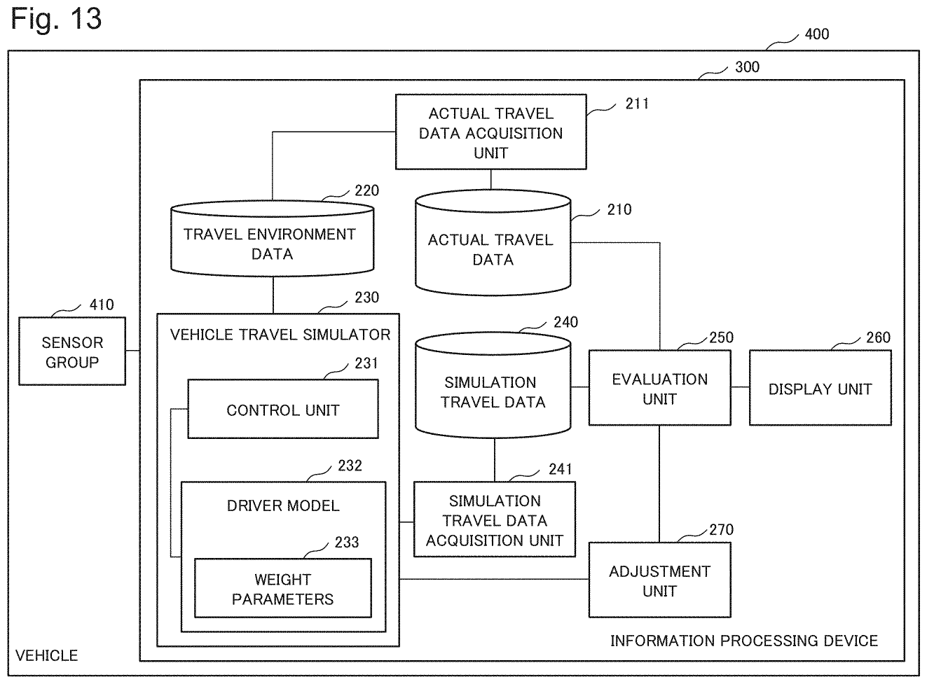

FIG. 13 is a block diagram illustrating a configuration of a vehicle 400 according to a fourth example embodiment of the present invention. As illustrated in FIG. 13, the vehicle 400 according to the fourth example embodiment includes the information processing device 300 according to the above-mentioned third example embodiment and a sensor group 410.

The sensor group 410 includes one or a plurality of sensors that acquire information on a traveling vehicle such as a position, a direction, speed, acceleration of the vehicle. The actual travel data acquisition unit 211 of the information processing device 300 acquires the information on the traveling vehicle, which is acquired by the sensor group 410, as the actual travel data, and stores the information in the simulation travel data storage unit 240.

Similarly to the operation described in the third example embodiment, based on the plurality of evaluation indexes, the information processing device 300 compares the actual travel data stored as described above and the simulation travel data generated by the vehicle travel simulator 230. Further, the adjustment unit 270 adjusts the weight parameters 233 in such a way as to put more emphasis on an evaluation index with a larger deviation degree.

As described above, according to the fourth example embodiment, the information processing device 300 and the sensor group 410 are installed in the vehicle 400, and the information processing device 300 adjusts the weight parameters 233, based on the actual travel data acquired by the sensor group 410.

By adopting this configuration, according to the fourth example embodiment, the following effects can be exerted even when the driver model 232 of the vehicle travel simulator 230, which is initially installed in the vehicle 400, is a driver model indicating average behavior. Specifically, the sensor group 410 acquires information on the vehicle 400, and the information processing device 300 generates a driver model in which a preference of a driver is reflected based on the information. Thus, an effect of being capable of controlling travel with the driver model in consideration of a balance among the plurality of evaluation indexes can be exerted.

### Fifth Example Embodiment

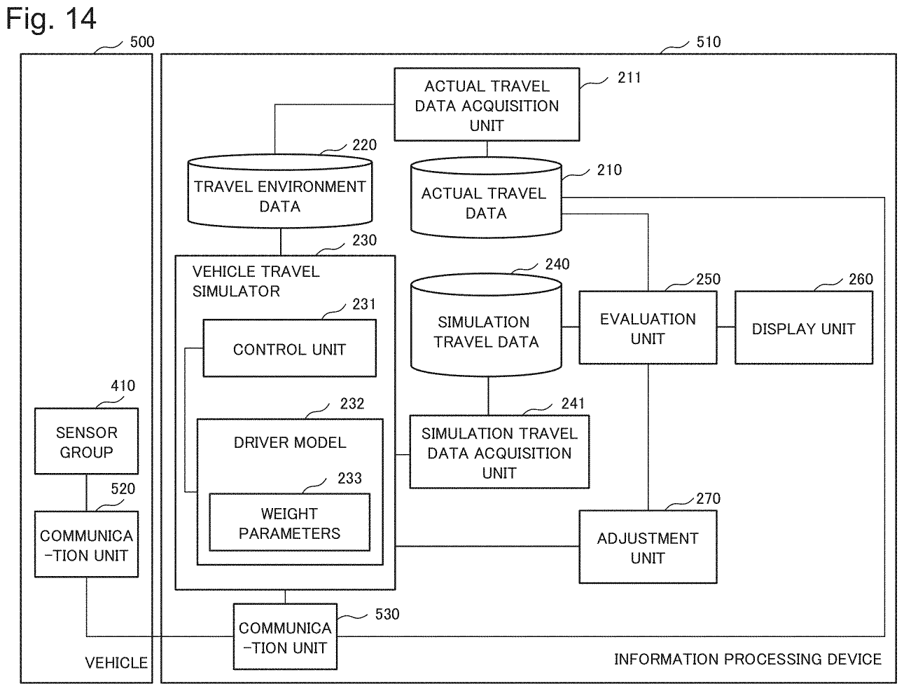

FIG. 14 is a block diagram for illustrating configurations of a vehicle 400 and an information processing device 510 according to a fifth example embodiment of the present invention. As illustrated in FIG. 14, the vehicle 500 according to the fifth example embodiment includes the sensor group 410 described in the fourth example embodiment and a communication unit 520. Further, the information processing device 510 according to the fifth example embodiment includes a communication unit 530 in addition to the configuration of the third example embodiment described in the information processing device 510.

The information processing device 510 is installed outside of the vehicle 500. The vehicle 500 and the information processing device 510 communicate with each other via the communication unit 520 and the communication unit 530.

The information processing device 510 acquires, via the communication unit 530, information on a traveling vehicle such as a position, a direction, speed, acceleration of the vehicle, which is acquired by the sensor group 410 of the vehicle 500, and stores the acquired information as the actual travel data in the actual travel data storage unit 210. As described in the third example embodiment, the information processing device 510 adjusts the weight parameters 233, based on the stored actual travel data, and transmits, to the vehicle 500, the driver model 232 containing the weight parameters 233 having been adjusted.

As described above, the vehicle 500 according to the fifth example embodiment includes the sensor group 410 and the communication unit 520, and the information processing device 510 includes the communication unit 530 that receives information acquired by the sensor group 410. The information processing device 510 adjusts the weight parameters 233, based on the received information, and transmits, to the vehicle 500, the driver model 232 containing the weight parameters 233 having been adjusted.

By adopting this configuration, according to the fifth example embodiment, the following effects can be exerted even when the driver model 232 of the vehicle travel simulator 230, which is initially installed in the information processing device 510, is a driver model indicating average behavior. Specifically, the sensor group 410 acquires information on the vehicle 500, and the information processing device 510 generates a driver model in which a preference of a driver is reflected based on the information and transmits the driver model to the vehicle 500. Thus, an effect of being capable of controlling travel of the vehicle 500 with the driver model in consideration of a balance among the plurality of evaluation indexes can be exerted.

Further, even when a driver drives different vehicles, an effect of being capable of controlling travel in such a way as to reflect a preference of the driver can be exerted by receiving, from outside, a driver model in which the preference of the driver is reflected.

Note that, in the present example embodiment, description is made on the case where the vehicle 500 transmits and receives information with the information processing device 510 via the communication units 520 and 530. However, the present invention is not limited thereto, and information may be exchanged through use of a portable storage medium such as a memory card.

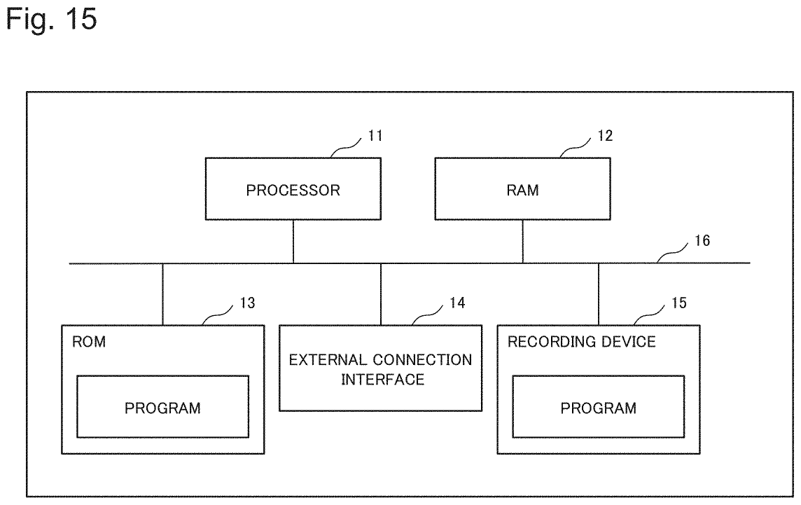

Note that, the units of the processing information device illustrated in FIG. 1 and the like are achieved by hardware resources illustrated in FIG. 15. That is, the configuration illustrated in FIG. 15 includes a processor 11, a random access memory (RAM) 12, a read only memory (ROM) 13, an external connection interface 14, a recording device 15, and a bus 16 for connecting the components.

In each of the example embodiments described above, as one example of execution by the processor 11 illustrated in FIG. 15, description is made on the example in which the processor 11 reads the computer program in the RAM 12 to execute the computer program after the computer program that enables the above-mentioned function is supplied to the information processing device. However, a part of or the entirety of the functions illustrated in the blocks of the information processing device illustrated in FIG. 1 and the like may be achieved as hardware.

The supplied computer program may be stored in a readable/writable memory (temporary storage medium) or a computer-readable storage device such as a hard disk device. Further, in such case, it can be understood that the present invention includes codes indicating the computer program or a storage medium in which the computer program is stored.

With reference to the example embodiments described above, description is made on the present invention. However, the present invention is not limited to the example embodiments described above. That is, within the scope of the present invention, the present invention may adopt various modes such as various combinations and selections made from the various disclosed elements that can be understood by a person skilled in the art.

This application is based upon and claims the benefit of priority from Japanese Patent Application No. 2017-056889, filed on Mar. 23, 2017, the disclosure of which is incorporated herein in its entirety by reference.

### REFERENCE SIGNS LIST

11 Processor
12 RAM
13 ROM
14 External connection interface
15 Recording device
16 Bus
100, 200, 300, 510 Information processing device
110 Actual travel data acquisition unit
120 Simulation travel data acquisition unit
130 Comparison unit
210 Actual travel data storage unit
211 Actual travel data acquisition unit
220 Travel environment data storage unit
230 Vehicle travel simulator
231 Control unit
232 Driver model
233 Weight parameter
240 Simulation travel data storage unit
241 Simulation travel data acquisition unit
250 Evaluation unit
260 Display unit
270 Adjustment unit
400 Vehicle
410 Sensor group
500 Vehicle
520, 530 Communication unit

What is claimed is:

1. An information processing device comprising:
at least one memory storing a computer program; and
at least one processor reading the computer program to perform:
acquiring actual travel data acquired during travel of a vehicle, which is performed by a driver;
acquiring simulation travel data acquired by a simulator that simulates travel of the vehicle, which is performed by the driver, through use of travel environment data indicating a travel environment relating to the travel and a driver model for determining an operation of the vehicle with respect to the travel environment; and
comparing values for a plurality of indexes in the actual travel data and values for the plurality of indexes in the simulation travel data, and which outputs a comparison result.

2. The information processing device according to claim 1, wherein
the driver model determines an operation of the vehicle through use of a predetermined objective function using weights relating to the plurality of indexes, and
the at least one processor is further configured to perform: adjusting weights relating to the plurality of indexes, based on differences between the values for the plurality of indexes in the actual travel data and the values for the plurality of indexes in the simulation travel data.

3. The information processing device according to claim 2, wherein
the at least one processor is further configured to perform: adjusting the weights, which are used in the objective function, to be larger as the values for the indexes have larger differences therebetween among the compared values for the plurality of indexes in the actual travel data and values for the plurality of indexes in the simulation travel data.

4. The information processing device according to claim 2, wherein
the at least one processor is further configured to perform: acquiring the differences, based on time-averaged error rates of the values for the plurality of indexes in the actual travel data and the values for the plurality of indexes in the simulation travel data.

5. A travel data processing method comprising:
acquiring actual travel data acquired during travel of a vehicle, which is performed by a driver, and
simulation travel data acquired by a simulator that simulates travel of the vehicle, which is performed by the driver, through use of travel environment data indicating a travel environment relating to the travel and a driver model for determining an operation of the vehicle with respect to the travel environment; and
comparing values for a plurality of indexes in the actual travel data and values for the plurality of indexes in the simulation travel data and outputting a comparison result.

6. The travel data processing method according to claim 5, wherein
the driver model determines an operation of the vehicle through use of a predetermined objective function using weights relating to the plurality of indexes, and
the method further comprises adjusting weights relating to the plurality of indexes, based on differences between the values for the plurality of indexes in the actual travel data and the values for the plurality of indexes in the simulation travel data.

7-8. (canceled)

9. A program recording medium which records a computer program causing a computer to execute:
processing of acquiring actual travel data acquired during travel of a vehicle, which is performed by a driver;
processing of acquiring simulation travel data acquired by a simulator that simulates travel of the vehicle, which is performed by the driver, through use of travel environment data indicating a travel environment relating to the travel and a driver model for determining an operation of the vehicle with respect to the travel environment; and
processing of comparing values for a plurality of indexes in the actual travel data and values for the plurality of indexes in the simulation travel data, and outputting a comparison result.
